(19) United States
(12) Patent Application Publication
(10) Pub. No.: US 2008/0073430 A1
(43) Pub. Date: Mar. 27, 2008

(54) Sense and Respond Purchase Restriction Management System

(76) Inventor: Louis S. Sickenius, Longmont, CO (US)

Correspondence Address: DILLON & YUDELL, LLP, 8911 N CAPITAL OF TEXAS HWY, SUITE 2110, AUSTIN, TX, 78759, US

(21) Appl. No.: 11/534,502

(22) Filed: Sep. 22, 2006

(51) Int. Cl. G06K 15/00; G06Q 20/00

(52) U.S. Cl. 235/383; 705/17

(57) ABSTRACT

A system, method and computer-readable medium for managing a point-of-sale (POS) purchase transaction. In one embodiment, an account code is presented by a purchaser and read/scanned at a POS station. The account code associates a payment account with account data that includes one or more account restriction codes. A product code that is tangibly affixed to a product is read at the POS station. The product code associates the product with product profile data that includes one or more product restriction codes. The account data and product profile data are accessed and the account restriction codes are compared with the product restriction codes. In response to determining a pre-specified relation between the account restriction codes and product restriction codes, a purchase restriction response is automatically initiated.

### BACKGROUND OF THE INVENTION

1. Technical Field

The present invention relates generally to management of point-of-sale purchase transactions. In particular the present invention relates to a system and method for managing point-of-sale transactions in accordance with pre-specified relations between product codes and payment account information.

2. Description of the Related Art

Purchase transactions for many products and services are subject to a variety of restrictions and limitations. Many products, such as alcoholic beverages, tobacco, and firearms have legal purchasing restrictions relating to age, criminal record, etc. Purchasing restrictions may also be imposed on a particular charge account, such as a governmental aid credit card, so that the user of the account ostensibly bears some level of responsibility regarding the type of purchase transactions allowed to be placed on the account.

A variety of other non-legal and less formal restrictions on sales purchases involve limitations or conditions applicable to individual persons or identifiable groups of people. For example, parents may attempt to impose extra-legal restrictions on their children's access to movies, music, the Internet etc. Many desired purchasing restrictions may be self-imposed such as those related to dieting, food allergies, etc.

For many point-of-sale (POS) transactions, such as the sale of cigarettes, the subjective judgment of the on-site salesperson and his/her manager relating to the purchaser and his/her identification may be the first and final restriction enforcement mechanism. The purchase of higher security products, such as firearms, often require a fairly extensive showing of identification as well as a background check that is often referred out to and performed by law enforcement personnel. Such checks are often narrowly tailored to determine, for example, whether or not the purchaser has a felonious criminal record.

POS identification checks are often unreliable, resulting in purchasers and/or vendors being subject to substantial civil and/or criminal penalties in case of legal violations. Background checks are time consuming and cumbersome, often relying on information obtained from one or more outside sources.

It can therefore be appreciated that a need exists for a method, system, and computer program product for managing restrictions related to purchase transactions. The present invention addresses this and other needs unresolved by the prior art.

### SUMMARY OF THE INVENTION

A system, method and article of manufacture for managing a point-of-sale (POS) purchase transaction are disclosed herein. In one embodiment, an account code is presented by a purchaser and read/scanned at a POS station. The account code associates a payment account with account data that includes one or more account restriction codes. A product code that is tangibly affixed to a product is read at the POS station. The product code associates the product with product profile data that includes one or more product restriction codes. The account data and product profile data are accessed and the account restriction codes are compared with the product restriction codes. In response to determining a correlation between the account restriction codes and product restriction codes, a purchase restriction response is automatically initiated.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram illustrating a purchase restriction management system in accordance with the present invention;

FIG. 2A is a tabular representation of account profile records maintained and utilized by the purchase restriction management system of the present invention;

FIG. 2B is a tabular representation of product profile records maintained and utilized by the purchase restriction management system of the present invention; and

FIG. 3 is a high-level flow diagram depicting processing steps performed during purchase restriction management in accordance with the present invention.

### DETAILED DESCRIPTION OF ILLUSTRATIVE EMBODIMENT(S)

The present invention is generally directed to facilitating efficient, reliable, and comprehensive enforcement of purchasing restrictions. Some restrictions may be legally imposed, such as age restrictions on purchasing alcoholic beverages. Other restrictions may not be legal, instead relating, for example, to an individual's preferences, disposition, status, condition, etc. For example, a person picking up a prescription may have a severe allergy to a particular medication and depends on the individual attention and judgment of the prescribing doctor and/or pharmacist to prescribe and dispense accordingly. The present invention applies to these as well as the myriad of other possible POS purchase restrictions.

In general, the devices that may comprise or relate to the present invention include a wide variety of data processing technology. The depicted embodiments are not meant to imply architectural limitations with respect to the invention. Therefore, while the figures depict a particular configuration and organization of hardware, software, data structures, and network components, it should be noted that the present invention is not limited to the features and configuration of the depicted embodiments.

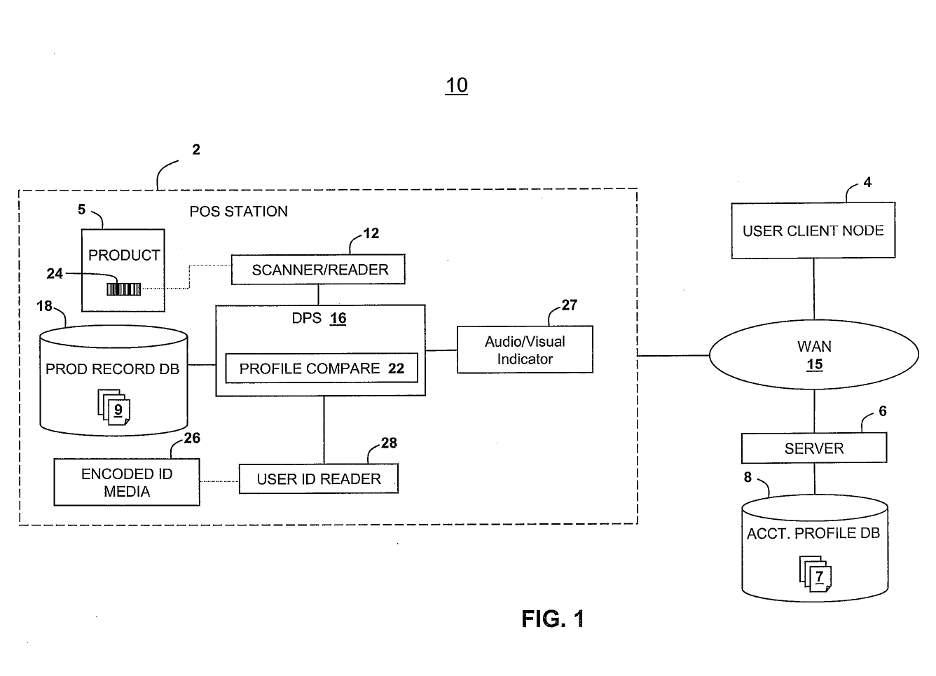

With reference now to the figures, wherein like reference numerals refer to like and corresponding parts throughout, and in particular with reference to FIG. 1, there is depicted a purchase restriction management system (PRMS) 10 in accordance with the present invention. A point-of-sale (POS) station 2 is featured within PRMS 10. Similar to most purchase transaction systems, PRMS 10 is distributed over a networked computing environment. When implemented in a distributed, networked computing environment, purchase transaction tasks may be performed by remote processing devices that are linked through a communications network. Examples of such distributed computing environments include local area networks, enterprise-wide computer networks, and wide area networks such as the Internet. In a distributed computing environment, program modules may be located in both local and remote memory storage devices.

PRMS 10 operates in a networked environment using logical connections between POS station 2 and one or more remote processing devices such as a server system 6 and client node 4. In the depicted embodiment, client node 4 is preferably a personal data processing device such as a personal computer or handheld computing device. The logical network connectivity depicted in FIG. 1 is provided by a wide area network (WAN) 15. Whether connected to WAN 15 individually or through a LAN networking environment, data processing system 16 and/or client node 4 are typically connected to WAN 15 through one of a variety of possible types of network interfaces.

The distributed PRMS computing environment depicted in FIG. 1 further comprises server system 6 communicatively coupled to POS station 2 via WAN 15. Server system 6 preferably runs database and/or file server programs (not depicted) which handle client requests to update or otherwise modify or retrieve account data stored as account records 7 within an account database 8. Each of account records 7 is associated with a specified payment account (e.g. credit or debit card account) by an account ID code presented by the purchaser during a POS transaction. In addition to storing standard types of account information such as authorized user and account balance information, each of account records 7 contains encoded account restriction data for the associated account.

As explained and depicted in further detail below, the account restriction data within account records 7 is preferably organized into pre-specified categories for maximum system cross-compatibility. One such specified category of account restriction data may comprise encoded legal status information such as codes relating to underage and felony conviction status. Another such category may comprise account restriction codes relating to health or diet matters such as allergies, blood type, etc. As explained in further detail below, the categorized account restrictions contained within account records 7 may be advantageously utilized in conjunction with similarly categorized product-specific restrictions to enable appropriate enforcement or acknowledgement of purchase restrictions applicable to a given POS purchase transaction.

POS station 2 features several familiar components typical of conventional POS cashier stations including a data processing system 16 that may be contained within or is otherwise in communicative contact with a sales register (not depicted) that may be operated by a salesperson or by the purchaser him or herself. POS station 2 further includes a product scanner/reader 12 utilized to read an identification code that is associated with, and typically tangibly affixed to, a readily accessible surface of a product 5.

Scanner/reader 12 may be a hand-held or fixed mount unit that reads coded identification tags, labels, or other media in or on which product identification codes may be encoded. In preferred embodiments, scanner/reader 12 may be a barcode scanner, an RFID reader, or other such device for reading product-affixed codes. Familiar to the vast majority of retail purchasers, devices such as product scanner/reader 12 greatly facilitate fast and efficient registering of individual products during POS purchase transactions. FIG. 1 depicts scanner/reader 12 as a discretely separate entity with respect to data processing system 16. In an alternate embodiment, data processing system 16 may comprise circuit and logic modules and devices that may be incorporated within scanner/reader 12 such as for portable scanning devices.

Scanner/reader 12 is electrically or otherwise communicatively coupled to deliver product code data obtained or derived from product-affixed codes to data processing system 16. Conventionally, data processing system 16 processes product code data received from scanner/reader 12 to determine and enter the correct sales prices of the corresponding products to facilitate the POS purchase transaction process. In this manner, a primary utility of barcode product encoding and scanning is to increase purchase transaction efficiency by eliminating the need for the sales clerk to remember and manually input the sales prices of the products.

A POS purchase transaction commences with scanner/reader 12 reading a product ID code encoded onto an ID tag 24 which is affixed to product 5. In the depicted embodiment, ID tag 24 has a barcode encoded onto and readable from its outer surface which is scanned/read by scanner/reader 12. The barcode is generally a machine-readable, visually discernable representation of information, such as by parallel lines, dot patterns, etc. Barcode systems or derivations of barcode coding systems such as those following the Universal Product Code (UPC), European Article Number (EAN), Japanese Article Numbering (JAN) System, or International Article Numbering System (IAN) encoding symbologies may be used for the barcode encoded onto ID tag 24.

For reading a barcoded product ID such as the barcode on ID tag 24, scanner/reader 12 may be an optical barcode reader containing decoder circuitry for analyzing the barcode's image data rendered by an optical conductor (not depicted) and sending the barcode's data content to data processing system 16 to be processed. It should be noted that while FIG. 1 depicts product 5 as having a barcode type identifier, alternate embodiments may utilize other types of product-affixed encoded identifiers such as RFID tags in conjunction with compatible detection/decoding functionality such as an RFID reader within scanner/reader 12. If implemented using RFID tagging, ID tag 24 and scanner/reader 12 may be designed and encoded in conformity with the Electronic Product Code, (EPC) family of RFID coding schemes.

In response to receiving the barcode ID information from scanner/reader 12, data processing system 16 accesses and retrieves a product record identified by the barcode from among a set of product records 9 stored within a product record database 18. The retrieved one of product records 9 contains the price and other commerce or inventory-related information specified for product 5 either individually or categorically (i.e. information specified for a class, type, or category of which product 5 is a member). In addition to the purchase price, the barcode product record association may include other product information such as inventory lists and expiration dates, which enable, for example, an automatic inventory update by data processing system 16 responsive to reading the barcode during a purchase transaction. In this manner, the barcode on ID tag 24 associates product 5 with a purchase price and possibly other product profile data.

The present invention provides a purchase transaction management mechanism/technique whereby a product ID code, such as a barcode, affixed or otherwise associated with a product, in addition to facilitating the payment and inventory maintenance aspects of purchase transactions, further associates the product with product-specific purchase restriction data. In accordance with the present invention, and as depicted and explained in further detail below, such purchase restrictions are encoded and maintained within product records 9, enabling product-affixed ID codes such as barcodes to associate products with the purchase restrictions in a manner enabling efficient, reliable, and comprehensive application and enforcement of purchasing restrictions. The product-specific purchasing restrictions for product 5 within product records 9 preferably include a tabular or otherwise categorically organized set of product restriction codes. Individually or categorically, the product restriction codes preferably include one or more coded entries within specified purchase restriction categories/classes such as health or security-related. When the product record for product 5 is retrieved, the product profile data in the record includes one or more such coded restrictions. The product restriction codes are subsequently received as input by a profile compare module 22 which compares or otherwise processes the product restriction codes with account-specific purchasing restriction codes retrieved and input into profile compare module 22 as now described.

As with most purchase stations accepting account-based (i.e. non-cash) payment, POS station 2 includes a user ID reader 28 that reads an encoded ID media 26 such as a card or other encoded payment medium presented by the purchaser during a POS transaction. User ID reader 28 includes electronic, optical, magnetic sensing, and/or other sensing modules for reading encoded ID media 26 such as a magnetic stripe on a card, an RFID encoded card, etc., to retrieve and decode the account ID. Once decoded, the account ID is utilized by data processing system 16 to locate and identify an account record containing associated account data. If the account ID specifies a credit or debit card account, for example, the account data may include various authorized user identification data, a specified account balance, and other data relating to features common to credit or debit payment accounts.

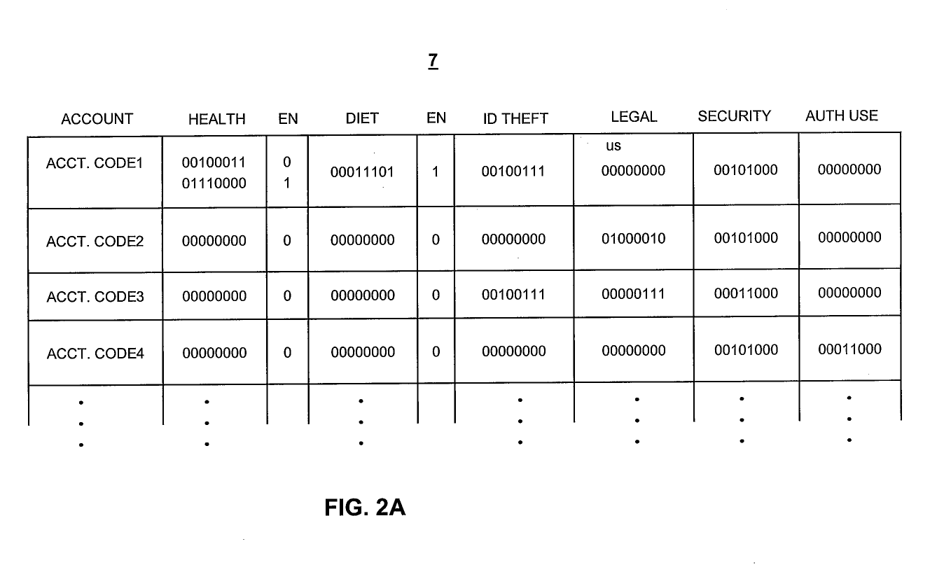

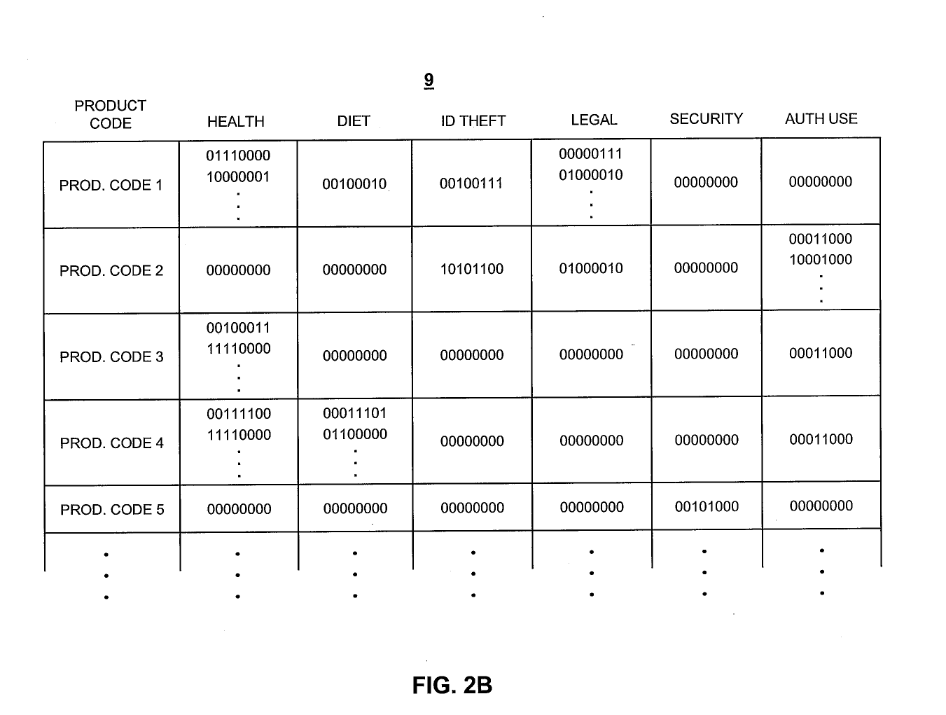

In the depicted embodiment, the account data associated with the account ID decoded from ID media 26 is retrieved from account records 7 maintained and managed within account database 8. Server 6 processes client requests, including requests from one or more POS stations, such as POS station 2, to retrieve account records corresponding to payment accounts identified during POS transactions. In addition to handling POS station requests for account data, server 6 and database 8 provide a network and processing interface by which the content of account records 7 may be maintained and managed by remote nodes such as client node 4 which is communicatively coupled to server 6 via WAN 15. In one embodiment, server 6 and account database 8 include logic and programming modules for processing requests received from remote client nodes to modify, add, remove, or otherwise manage various data within the account records 7. Further description of remote modification of account data is described in further detail below with reference to FIG. 2A.

Retrieval of account restriction codes continues with data processing system 16 utilizing the account ID code to request and retrieve the account record containing the restriction codes from server 6. Profile compare module 22 then compares or otherwise processes the account restriction codes with respect to the product restriction codes for product 5 to determine whether the purchase of product 5 is in some manner unauthorized or restricted. In the depicted embodiments explained below, compare module 22 determines the restriction status of the purchase of product 5 by comparing product restriction codes falling within a set of one or more restriction categories such as “health” or “legal” with account restriction codes falling within the same or otherwise corresponding categories.

FIG. 2A illustrates a more detailed, tabular representation of account records 7 as maintained and utilized by PRMS 10. Each of account records 7 has an identifying payment account code that associates a payment account, such as a checking or credit card account, with categorized purchase restriction data. In the depicted embodiment, account records 7 include records having payment account codes ACCT CODE1, ACCT CODE2, ACCT CODE3, and ACCT CODE4. Account records 7 contain data entry fields within specified restriction categories including HEALTH, DIET, ID THEFT, LEGAL, SECURITY, AUTH USE.

FIG. 2B depicts a similarly tabularized representation of product records 9 having product codes corresponding to various classes or categories of products. The depicted embodiment includes records having barcoded product identifiers including PROD CODE1 for alcoholic beverages, PROD CODE2 for gasoline, PROD CODE3 for sweetened beverages, PROD CODE4 for packaged meals, and PROD CODE5 for electronic igniters. Product records 9 contain data entry fields within the same restriction classes HEALTH, DIET, ID THEFT, LEGAL, SECURITY, and AUTH USE as for account records 7.

In the example embodiment, the account and product records contain 8-bit restriction code fields for each of the restriction classes. For example, the record for ACCT CODE1 includes two 8-bit restriction codes, 00100011 and 01110000, under the HEALTH class. These two codes may represent or otherwise correspond to health conditions that are material in some way to potential purchasing choices made by the authorized user of the payment account ACCT CODE1. For example, the 00100011 code may correspond to a severe diabetic condition possibly experienced by the account user him/her or others such as immediate family members of the user. During POS transaction processing using ACCT CODE1, the 00100011 account restriction code is processed by compare module 22 to determine whether the purchased product(s) pose a concern with respect to the diabetic condition reflected by the account restriction code. Compare module 22 processes the account restriction code in conjunction with product restriction code(s) to determine whether purchase of a given product warrants some level of restriction response at the POS station. Continuing with the example in which the 00100011 account restriction code corresponds to a diabetic condition, if the ACCT CODE1 payment account is used to attempt to purchase a soft drink carrying the PROD CODE3 product code, compare module 22 compares the respective restriction codes contained in the respective ACCT CODE1 and PROD CODE3 records. As seen in FIG. 2B, the 00100011 code is also contained in the PROD CODE3 record for sweetened beverages. Upon finding the matching 00100011 codes in the respective HEALTH class fields, compare module 22 sends an alert signal or otherwise automatically initiates a purchase restriction response at POS station 2 such as via an audio and/or visual warning or alarm displayed/transmitted from an audio/visual indicator 27 coupled to data processing system 16.

Another account restriction within account records 7 is represented by the 00011101 code contained in the DIET restriction class field of the ACCT CODE1 product record. The 00011101 code may represent, for example, an acute food allergy to peanuts. In this case, the product restriction code 00011101 is applicable and utilized by the mechanism of the invention to ensure that the purchaser presenting the encoded account ID is at least alerted to products presented at POS station 2 that contain small or otherwise facially concealed quantities of peanut material. If, for example, the ACCT CODE1 payment code is used to attempt to purchase a frozen dinner package carrying the PROD CODE4 product code, compare module 22 compares the respective account and product restriction codes in the respective class fields and determines by the presence of the 00011101 code in the DIET class field of the product record that the dinner package contains peanut content. Responsive to finding matching codes in the respective DIET class fields of the account and product records, compare module 22 delivers an alert signal prompting audio/visual indicator 27 to issue a secondary visual and/or audible warning signal.

The depicted LEGAL and SECURITY restriction classes contain account and product restriction codes that enable convenient and centralized application and enforcement of a multitude of legal and security-related standards that have conventionally been addressed in an ad hoc and sometimes unreliable manner. As an example, and assuming that the 00000111 code in the LEGAL class field of the ACCT CODE3 record may be used as an indicator of legally underage status (e.g. under 21). The 00000111 account restriction code within the LEGAL class field would then be used to prompt a purchase restriction response such as blocking access to payment account resources or generating an audible and/or visual alert signal or indicator when the account is used to attempt to purchase products, such as alcoholic beverages, having product restriction codes that correlate in a specified manner (matching codes in the depicted embodiment) to the account restriction code. As with the LEGAL class, the SECURITY restriction class enables the invention to comprehensively impose purchasing restrictions that would otherwise require substantial time and effort to individually address. In the depicted embodiment, the codes contained in the SECURITY restriction class field may include codes representing citizenship. For example, the 00101000 code contained in the SECURITY class fields of the ACCT CODE1, ACCT CODE2, and ACCT CODE4 account records may represent United States citizenship while the 00011000 code contained in the SECURITY class field of the ACCT CODE3 account record may represent Canadian citizenship.

Many products may have associated records that make no distinction relating to citizenship as shown by the null fields within the SECURITY class fields for PROD CODE1 (alcoholic beverage), PROD CODE2 (gasoline), PROD CODE3 (sweetened beverage), and PROD CODE4 (packaged meal). For products that pose a potentially extreme hazard to public safety, however, citizenship may be a valuable criterion in implementing and enforcing purchasing restrictions as illustrated by the inclusion of US citizenship code 00101000 in the SECURITY class field of the PROD CODE5 (electronic igniter) product record. The exemplary use of citizenship as a purchasing restriction criterion may require that compare module 22 include logic and modules that produce an essentially inverse processing response from that for the previously discussed restrictions. Namely, rather than initiating a restriction response if a match is found (i.e. the product restriction code relates in a pre-specified manner to the account code in the same restriction class field), compare module 22 may determine whether to initiate a restriction response for a security-based product restriction in an exclusive manner, initiating a restriction response if the citizenship or other code within the SECURITY class field of the account record fails to match or cannot otherwise be correlated with a citizenship code within the SECURITY class field of the product record.

The foregoing purchase restrictions specify and enforce purchasing restrictions as they relate and are applicable to some characteristic or status of a person, often the authorized account user. The depicted embodiment provides another mechanism for purchase exclusivity that is applicable to the characteristics of the payment account per se. The need for account-based restrictions may arise, for example, in relation to public or emergency assistance payment accounts provided by the government and intended for limited living expense uses rather than recreational uses. In the depicted embodiment, the AUTH USE restriction class for account records 7 and product records 9 may contain codes indicating purchasing restrictions that are directly applicable to accounts either individually or categorically. For account records 7, the AUTH USE class field specifies an authorized usage code for the corresponding account. As shown in FIG. 2A, records ACCT CODE1, ACCT CODE2, and ACCT CODE3 have no authorized usage code (null). The ACCT CODE4 record has a 00011000 authorized usage code in the AUTH USE class field. When the payment account corresponding to the ACCT CODE4 record is used in a POS purchase transaction, the restriction codes for product(s) to be purchased are compared by compare module 22 with the 00011000 account restriction code to determine whether or not to initiate a restriction response.

In a further feature of the depicted embodiment, the account data contained in account records 7 further includes enablement flags indicating the enablement status of each of the account restriction codes. When the account record for product 5 is retrieved, profile compare module 22 reads the enablement flags within the record to determine whether the corresponding account restriction codes are presently applicable to the point-of-sale purchase transaction. As illustrated in FIG. 2A, the enablement flag for the 00100011 diabetes code in the HEALTH class field of the ACCT CODE1 record is non-asserted while that for the 01110000 code designating heart disease, for example, is asserted. Assuming an asserted high convention, the foregoing enablement flag settings result in the diabetes condition being ignored while the heart disease condition is accounted during the restriction code comparison by profile compare module 22. One or more of the enablement flags may be remotely asserted or de-asserted by a user at client node 4. In this manner, users can conveniently determine which restriction codes associated with their accounts will be activated at any given time.

The embodiment depicted in FIGS. 2A and 2B further addresses the problem of account and/or identification theft such as when a credit card is stolen. Conventionally, protection against unauthorized charges to a credit card largely depends on the attention and diligence of individual sales clerks who may or may not require independent identification from the person presenting a credit card. The depicted embodiment uses a designated class field, ID THEFT, to enable the fundamental mechanism of the present invention to assist in detecting and deterring unauthorized uses of stolen credit cards or other account code bearing media. Specifically, the ID THEFT class field of one or more of account records 7 may contain one or more restriction codes specified by an authorized user or otherwise as corresponding to products that an authorized user would not purchase. For example, and referring to FIGS. 2A and 2B, an ID THEFT code of 00100111 is specified for ACCT CODE1 and corresponds to the code included in the ID THEFT class field for PROD CODE1 indicating that authorized users will not purchase alcoholic beverages using this account. Responsive to compare module 22 determining a pre-specified relation between the codes contained in the respective ID THEFT class fields of an account record and product record, the restriction response includes blocking further access to account funds and preferably includes alerting local and/or remote security personnel of the attempted unauthorized usage of the account.

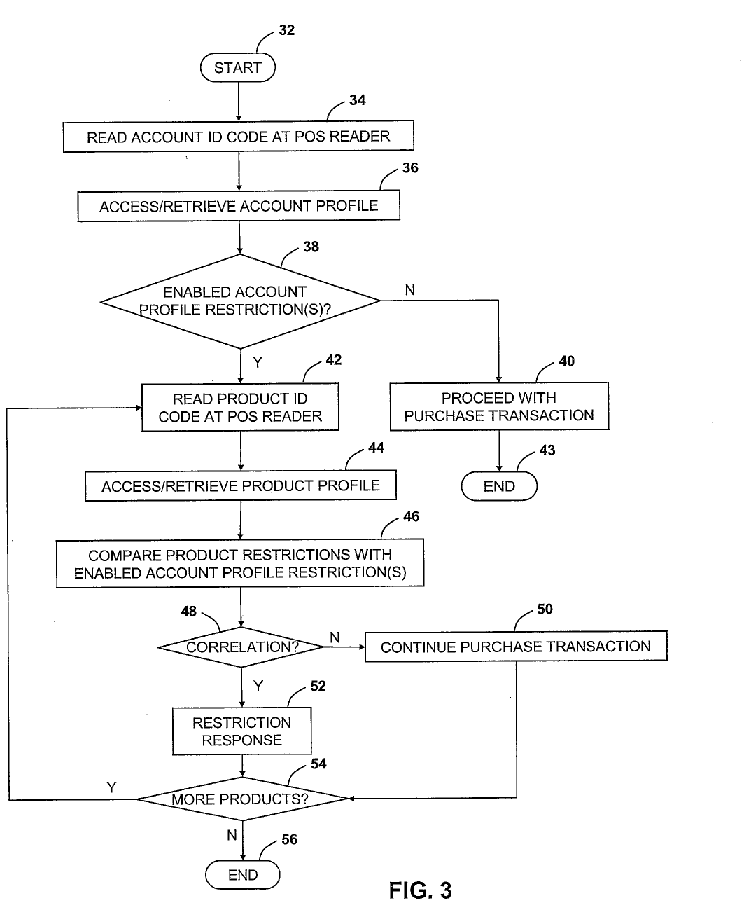

Referring to FIG. 3, there is illustrated a high-level flow diagram depicting processing steps performed by PRMS 10 during purchase restriction management in accordance with the present invention. The process commences as shown at steps 32 and 34 with user ID reader 28 reading an account ID code. The account ID code may be electronically, optically, or magnetically read and is encoded onto or within ID media 26, which may be a credit card, debit card, smart card, etc. presented by the purchaser before, during, or subsequent to the ID code for product 5 being electronically read. The account ID code is utilized by data processing system 16 to access and retrieve an account record for the payment account identified by the code as shown at step 36.

Next, as illustrated at step 38 compare module 22 determines whether or not the account record includes product restrictions such as those depicted and described with reference to account records 7 illustrated in FIG. 2A. As further depicted at step 38 compare module 22 determines whether the restrictions are enabled such as by the use of enable flags depicted in FIG. 2A. If no such enabled account restrictions are identified, the POS purchase transaction proceeds without further purchasing restriction processing as illustrated at steps 40 and 43. If enabled account restrictions are identified, purchase restriction processing is continued.

Step 42 depicts scanner/reader 12 reading the barcode on product tag 24. Data processing system 16 then accesses and retrieves product profile data such as one of product records 9 that is associated by the barcode with product 5 (step 44). Next, as depicted at step 46, compare module 22 compares the product restriction codes contained in the retrieved record with the enabled account restriction codes to determine whether a specified correlation such as an exact match can be found between the product restrictions and the account restrictions. If, as shown at steps 48 and 50, no restrictive correlation is found, the POS purchase transaction continues with processing of the next product using the procedure beginning at step 42. If a purchase restriction correlation is found, compare module 22 initiates a restriction response such as initiating an audible and/or visual alert signal or blocking access to resources in the payment account for purchase of product 5 for which the restriction correlation(s) were found (step 52). For a POS transaction involving multiple products, the process continues with processing of the next product (not shown) at step 42. Once the product ID codes for all of the products have been processed, the purchase restriction management process ends as shown at step 56.

It should be noted that the present invention is not limited to POS purchase transactions following all details depicted in FIG. 3 including the sequentially arranged steps. In an alternate embodiment, steps 42 and 44 may precede steps 34 and 36 without departing from the spirit and scope of the invention.

In the foregoing manner and using the techniques and features described above and claimed below, the present invention utilizes coordination between account restriction codes and product restriction codes to determine appropriate POS purchase restriction responses. The disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A method implemented by a data processing system for managing a point-of-sale purchase transaction comprising:
reading an account code presented by a purchaser, the account code associating a payment account with account data that includes one or more account restriction codes;
accessing the account data;
reading a product code that is tangibly affixed to a product, the product code associating the product with product profile data that includes one or more product restriction codes;
accessing the product profile data;
comparing the account restriction codes with the product restriction codes; and
in response to determining a pre-specified relation between the account restriction codes and product restriction codes, automatically initiating a purchase restriction response.

2. The method of claim 1, wherein the account restriction codes specify purchasing restrictions applicable to a person.

3. The method of claim 1, wherein the account restriction codes specify purchasing restrictions applicable to the payment account.

4. The method of claim 1, wherein the account data further includes an enablement flag for one or more of the account restriction codes, said method further comprising reading the enablement flag to determine whether the one of more of the account restriction codes is applicable to the point-of-sale purchase transaction.

5. The method of claim 4, further comprising, responsive to determining in accordance with the enablement flag that the one or more of the account restriction codes is not applicable to the point-of-sale purchase transaction, excluding the one or more of the account restriction codes in said determining a pre-specified relation between the account restriction codes and product restriction codes.

6. The method of claim 1, wherein said pre-specified relation between the account restriction codes and product restriction codes indicates a purchase restriction relating to the purchase of the product, said automatically initiating a purchase restriction response comprising generating an audible or visual purchase restriction signal.

7. The method of claim 1, wherein said pre-specified relation between the account restriction codes and product restriction codes indicates a purchase restriction relating to the purchase of the product, said automatically initiating a purchase restriction response comprising blocking access to account payment resources for purchase of the product.

8. A system for managing a point-of-sale purchase transaction comprising:
means for reading an account code presented by a purchaser, the account code associating a payment account with account data that includes one or more account restriction codes;
means for accessing the account data;
means for reading a product code that is tangibly affixed to a product, the product code associating the product with product profile data that includes one or more product restriction codes;
means for accessing the product profile data;
means for comparing the account restriction codes with the product restriction codes; and
means responsive to determining a pre-specified relation between the account restriction codes and product restriction codes, for automatically initiating a purchase restriction response.

9. The system of claim 8, wherein the account restriction codes specify purchasing restrictions applicable to a person.

10. The system of claim 8, wherein the account restriction codes specify purchasing restrictions applicable to the payment account.

11. The system of claim 8, wherein the account data further includes an enablement flag for one or more of the account restriction codes, said system further comprising means for reading the enablement flag to determine whether the one of more of the account restriction codes is applicable to the point-of-sale purchase transaction.

12. The system of claim 11, further comprising, means responsive to determining in accordance with the enablement flag that the one or more of the account restriction codes is not applicable to the point-of-sale purchase transaction, for excluding the one or more of the account restriction codes in said determining a pre-specified relation between the account restriction codes and product restriction codes.

13. The system of claim 8, wherein said pre-specified relation between the account restriction codes and product restriction codes indicates a purchase restriction relating to the purchase of the product, said means for automatically initiating a purchase restriction response comprising means for generating an audible or visual purchase restriction signal.

14. The system of claim 8, wherein said pre-specified relation between the account restriction codes and product restriction codes indicates a purchase restriction relating to the purchase of the product, said means for automatically initiating a purchase restriction response comprising means for blocking access to account payment resources for purchase of the product.

15. A computer-readable medium having tangibly encoded thereon computer-executable instructions for managing a point-of-sale purchase transaction, said computer-executable instructions adapted for performing a method comprising:
reading an account code presented by a purchaser, the account code associating a payment account with account data that includes one or more account restriction codes;
accessing the account data;
reading a product code that is tangibly affixed to a product, the product code associating the product with product profile data that includes one or more product restriction codes;
accessing the product profile data;
comparing the account restriction codes with the product restriction codes; and
in response to determining a pre-specified relation between the account restriction codes and product restriction codes, automatically initiating a purchase restriction response.

16. The computer-readable medium of claim 15, wherein the account restriction codes specify purchasing restrictions applicable to a person.

17. The computer-readable medium of claim 15, wherein the account data further includes an enablement flag for one or more of the account restriction codes, said method further comprising reading the enablement flag to determine whether the one of more of the account restriction codes is applicable to the point-of-sale purchase transaction.

18. The computer-readable medium of claim 17, said method further comprising, responsive to determining in accordance with the enablement flag that the one or more of the account restriction codes is not applicable to the point-of-sale purchase transaction, excluding the one or more of the account restriction codes in said determining a pre-specified relation between the account restriction codes and product restriction codes.

19. The computer-readable medium of claim 15, wherein said pre-specified relation between the account restriction codes and product restriction codes indicates a purchase restriction relating to the purchase of the product, said automatically initiating a purchase restriction response comprising generating an audible or visual purchase restriction signal.

20. The computer-readable medium of claim 15, wherein said pre-specified relation between the account restriction codes and product restriction codes indicates a purchase restriction relating to the purchase of the product, said automatically initiating a purchase restriction response comprising blocking access to account payment resources for purchase of the product.
